(19) United States
(12) Patent Application Publication
(10) Pub. No.: US 2007/0092051 A1
(43) Pub. Date: Apr. 26, 2007

(54) Method of producing radium-225 and decay products thereof

(76) Inventor: Stuart Lee Adelman, Albuquerque, NM (US)

Correspondence Address: STUART LEE ADELMAN, SUITE 513, 12200 ACADEMY RD NE, ALBUQUERQUE, NM, 87111, US

(21) Appl. No.: 11/520,948

(22) Filed: Sep. 14, 2006

Related U.S. Application Data
(60) Provisional application No. 60/718,576, filed on Sep. 19, 2005.

(51) Int. Cl. G21G 1/06

(52) U.S. Cl. 376/158

(57) ABSTRACT

Provided herein are methods of producing radium-225 and actinium-225 from an activated radium-226 source. Irradiation of the radium-226 by neutrons with energy effective to drive the reaction 226Ra (n,2n) 225Ra produces abundant radium-225 which decays to its daughter radionuclide actinium-225. Also provided is a system for supplying radiotherapeutic bismuth-213 in situ to a subject in need of radiotherapy using the actinium-225 produced by this method in a generator device effective to generate bismuth-213.

### BACKGROUND OF THE INVENTION

1. Field of the Invention

The present invention relates generally to the fields of nuclear physics and nuclear medicine. More specifically, the present invention relates to a method of producing radium-225 and actinium-225 from radium-226 for subsequent bismuth-213 generation.

2. Description of the Related Art

The radioactive isotope bismuth-213 (Bi-213) is clinically important in the treatment of numerous recalcitrant forms of tumors, both malignant and non-malignant, and including malignant hematologic diseases such as, but not limited to, acute myeloid leukemia, that form and grow in the human body and other malignant diseases; e.g., metastatic melanoma, with and without micrometastases.

Bismuth-213 is the daughter of an eight-member decay chain of radionuclides beginning with thorium-232, a common naturally-occurring isotope with a half-life of t_{1/2}=1.4056×10¹⁰ years. When thorium-232 is bombarded with thermal neutrons in a nuclear reactor, the product of the absorption of such a neutron is the isotope thorium-233 by the reaction, Th-232 (n,γ) Th-233, where Th-233 has a half-life t_{1/2}=22.32 minutes. Following the emission of a β particle by the thorium-233, uranium-233, another radioactive nuclide is formed. Uranium-233, decays by alpha emission to thorium-229, t_{1/2}=7.34×10³ years, which decays by alpha emission to radium-225. The radioactive decay of radium-225 is as follows: Ra-225, t_{1/2}≈14.82 days, emits a negative β particle to become actinium-225, actinium-225, t_{1/2}=10.0 days, emits an alpha particle to transmute into francium-221; francium-221, t_{1/2}=4.9 minutes, decays by alpha emission to astatine-217, t_{1/2}=32.3 milliseconds; which in its turn emits an alpha particle and transmutes into bismuth-213, the medically desired isotope.

However, the medically useful production of Bi-213; that is, its production and separation in a form that can be quickly administered to the patient is made especially difficult owing to Bi-213's extraordinarily short half-life. Bi-213 cannot be produced in the hospital, because its production in an accelerator, such as a cyclotron installed in the hospital itself, involves great, nearly impossible, physical parameters, unacceptably low production yields from a clinical point of view and very high production costs. Furthermore, production of Bi-213 by the Department of Energy was inefficient. The Department of Energy also was incapable of supplying enough Bi-213 to treat more one patient per month when they terminated their production efforts.

Recently, efforts have been made to utilize the parent radionuclide actinium-225, with its longer half-life t_{1/2}=10 days, as a generator to produce bismuth-213 in the clinical setting. However, currently the availability of actinium-225 in quantities to generate sufficient bismuth-213 to use in a clinical situation is extremely limited. In addition, the length of time required to produce these limited quantities of actinium-225 with its consequent high cost severely limits the number of patients that can be treated and prevents widespread use.

There is a recognized need in the art for new methods of production of medically useful radionuclides. Thus, the prior art is still deficient in the lack of methods of sufficient actinium-225 production. Specifically, the prior art is deficient in the lack of lower cost, higher yield methods of producing actinium-225 from activated radium-226. The present invention fulfills this long-standing need and desire in the art.

### SUMMARY OF THE INVENTION

The present invention is directed to a method of producing radium-225. The method comprises irradiating radium-226 with neutrons having an energy effective to substantially produce radium-225 therefrom. The present invention may comprise another method step of separating actinium-225 produced via decay of the radium-225 from the radium-226. The present invention may comprise yet another method step of enclosing the actinium-225 in a generator device effective to generate bismuth-213 therefrom. The present invention may comprise still another method step of re-irradiating the radium-226 with the neutrons described supra.

The present invention also is directed to a method of producing actinium-225. The method comprises irradiating radium-226 with neutrons having an energy effective to substantially produce radium-225 where the radium-225 subsequently decays thereby producing actinium-225. The present invention may comprise another method step of separating actinium-225 from the radium-226. The present invention may comprise yet another method step of enclosing the actinium-225 in a generator device effective to generate bismuth-213 therefrom. The present invention may comprise still another method step of re-irradiating the radium-226 with the neutrons described supra.

The present invention is directed to a related method of producing actinium-225. The method comprises irradiating radium-226 with neutrons at an energy effective to substantially produce radium-225, such that the radium-225 subsequently decays to actinium-225, separating the actinium-225 from the radium-226 and re-irradiating the radium-226. These method steps may be repeated. The present invention may comprise another method step of enclosing the actinium-225 in a generator device effective to generate bismuth-213 therefrom.

The present invention is directed further to a system for supplying radiotherapeutic bismuth-213 in situ to a subject in need of radiotherapy. The system comprises a reactor having a substantial flux of neutrons that is configured to generate neutrons with sufficient energy effective to activate radium-226 disposed therein via the reaction ²²⁶Ra (n,2n) ²²⁵Ra, means for separating actinium-225 produced via decay of radium-225 from the radium-226 and a generator device adapted to contain the actinium-225 and to generate radiotherapeutic bismuth-213 therefrom in situ for the subject.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention are briefly summarized. The above may be better understood by reference to certain embodiments thereof which are illustrated in the appended drawings. These drawings form a part of the specification. It is to be noted; however, that the appended drawings illustrate preferred embodiments of the invention and therefore are not to be considered limiting in their scope.

FIG. 1 illustrates the decay cascade of activated radium-225, produced from activated radium-226, to actinium-225 and bismuth-213.

FIG. 2 depicts the production activity of radium-225 as a function of irradiation time for a 1.0 g radium-226 target.

FIG. 3 depicts the radium-226 (n,2n) cross section curve as a function of energy (eV). The curve was calculated from the data in Table 1.

### DETAILED DESCRIPTION OF THE INVENTION

In one embodiment of the present invention there is provided a method of producing radium-225, comprising irradiating radium-226 with neutrons having an energy effective to substantially produce radium-225 therefrom.

Further to this embodiment the method comprises separating actinium-225 produced via decay of radium-225 from the radium-226. A representative amount of actinium-225 produced is about 15 mCi. In this further embodiment, the method may further comprise enclosing the actinium-225 in a generator device effective to generate bismuth-213 therefrom. Also, in this further embodiment the method may further comprise re-irradiating the radium-226.

In these embodiments the neutron energy may be about 5 MeV to about 20 MeV. Also, the radium-226 is irradiated about 20 to about 40 days. Preferably, the radium-226 is irradiated about 21 days. Furthermore, in these embodiments about 5 mCi of radium-225 is produced.

In another embodiment of the present invention there is provided a method of producing actinium-225, comprising irradiating radium-226 with neutrons having an energy effective to substantially produce radium-225, said radium-225 subsequently decaying thereby producing actinium-225.

Further to this embodiment the method comprises separating actinium-225 produced via decay of radium-225 from the radium-226. In this further embodiment, the method may further comprise enclosing the actinium-225 in a generator device effective to generate bismuth-213 therefrom. Also, in this further embodiment the method may further comprise re-irradiating the radium-226.

In these embodiments the neutron energy, the number of days during which the radium-226 is irradiated or re-irradiated and the amounts of radium-225 and actinium-225 produced are as described supra.

In a related embodiment there is provided a method of producing actinium-225, comprising (a) irradiating radium-226 with neutrons at an energy effective to substantially produce radium-225, such that the radium-225 subsequently decays to actinium-225; (b) separating the actinium-225 from the radium-226; (c) re-irradiating the radium-226; and (d) repeating steps (a) to (c). Further to this embodiment the method comprises enclosing the actinium-225 in a generator device effective to generate bismuth-213 therefrom.

In these embodiments the neutron energy, the number of days during which the radium-226 is irradiated or re-irradiated and the amounts of radium-225 and actinium-225 produced are as described supra.

In another embodiment of the present invention there is provided a system for supplying radiotherapeutic bismuth-213 in situ to a subject in need of radiotherapy, comprising a reactor having a substantial flux of fast neutrons, said reactor configured to generate neutrons with sufficient energy effective to activate radium-226 disposed therein via the reaction ²²⁶Ra (n,2n) ²²⁵Ra; means for separating actinium-225 produced via decay of radium-225 from the radium-226; a generator device adapted to contain the actinium-225 and to generate radiotherapeutic bismuth-213 therefrom in situ for the subject.

In this embodiment the neutron energy may be about 5 MeV to about 20 MeV. Also, in this embodiment the about 5 mCi of radium-225 may be produced from the activated radium-226. Furthermore, in this embodiment about 15 mCi of actinium-225 may be produced from the radium-225.

As used herein, the term, “a” or “an” may mean one or more. As used herein in the claim(s), when used in conjunction with the word “comprising”, the words “a” or “an” may mean one or more than one.

As used herein, the term “subject” refers to any recipient of radiotherapy, preferably bismuth-213 radiotherapy.

As used herein, the terms “supplying bismuth-213 in situ” or “generating bismuth-213 in situ” refer to the generating and processing of bismuth-213 in a form suitable for radiotherapy from an actinium-225 generator present either at the subjects side or bedside or within the immediate vicinity of the subject or within the clinical environment in which the subject is present.

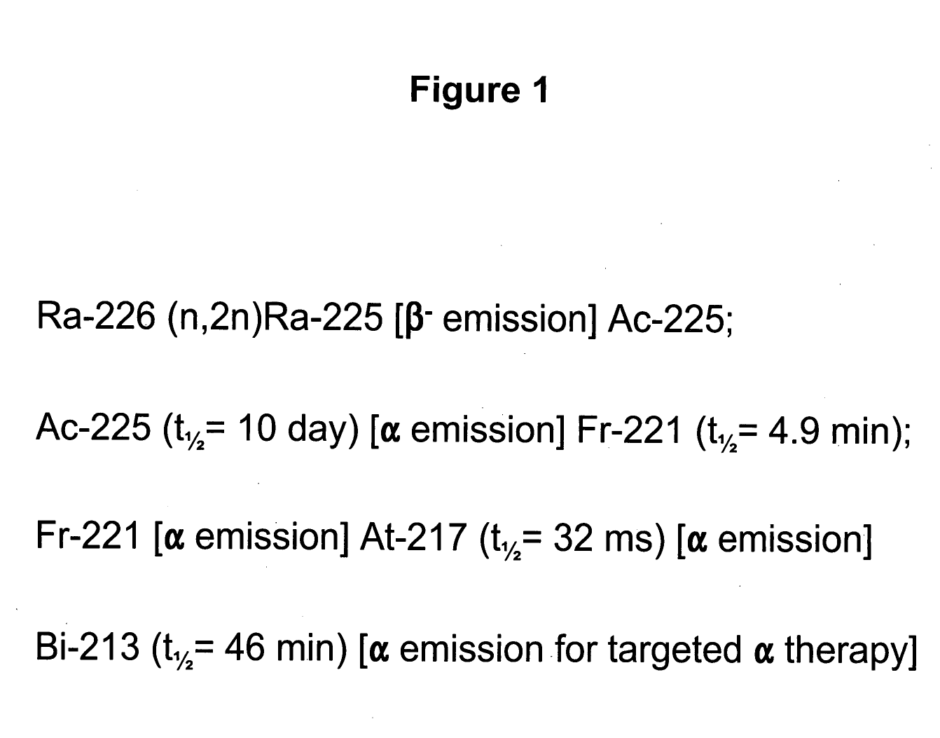

The present invention provides a method of abundant production of radium-225, the parent nuclide of actinium-225, from radium-226, a naturally occurring nuclide. Subsequent to activation of radium-226, radium-225 is produced via the reaction radium-226 (n,2n) radium-225. Radium-225 has a half-life, t_{1/2}=14.82 days and decays by the emission of a negative beta particle to actinium-225; i.e., Ra-225→c-225+β⁻ and finally to bismuth-213 via the sequential emission of three alpha particles (FIG. 1).

The method requires activating the Ra-226 in such a way that the product will, by natural decay, finally produce Bi-213 with a half-life of 46 minutes. The present invention provides for an amount of radium-226, preferably about 1 gm, to be irradiated or activated in a reactor having a substantial flux of fast neutrons, i.e., a fast neutron reactor, for a period of days at high neutron energies (Eₙ) effective to drive the reaction ²²⁶Ra (n,2n) ²²⁵Ra exclusively over the reaction ²²⁶Ra (n,γ) ²²⁷Ra which occurs at substantially lower or thermal neutron energies of about 0.025 eV. It is contemplated that the reaction ²²⁶Ra (n,2n) ²²⁵Ra will yield about 5 mCi of radium-225 per period of activation.

The high neutron energies preferably are about 5 MeV to about 20 MeV. Preferably, the radium-226 may be irradiated or activated about 20 to about 40 days, preferably about 20 to about 21 days. The method of activating radium-226 described herein provides an inexhaustible source of radium-225 and, by extension, actinium-225 given the radium-226 half-life t_{1/2}=1600 yrs. It is contemplated that the original 1 gm of radium-226 may be reactived as described herein about every 20-40 days.

Thus, the present invention further provides a method of producing actinium-225. The initial decay product of the radium-225 is actinium-225 [Ac-225], the precursor of bismuth-213. For every gram of Ra-226 that is activated, about 5 mCi of radium-225 is produced which naturally decays to produce about 15 mCi of actinium-225. After about three weeks of activation, the Ra-226 can be chemically processed to separate out the actinium-225. Such methods of radioisotopic chemical separation are well-known and standard in the art.

It is further contemplated that the actinium-225 produced by the method described herein may be packaged, enclosed or encased in a generator device effective to generate bismuth-213 from the decay of the actinium-225. Such generated bismuth-213 is efficacious for radiotherapy. Radioisotope generator devices are well-known and standard in the art. For example, and without being limiting, U.S. Pat. No. 6,603,127 discloses such a generator. Alternatively, a new generator device may be designed having improved safety features, such as, but not limited to, improved shielding against extraneous gamma radiation.

Thus, the present invention also provides a system for generating radiotherapeutic amounts of bismuth-213. The system is effective to generate and separate an abundant and effectively unlimited amount of actinium-225 from radium-226. The significantly longer half-life of actinium-225 allows for its delivery to a clinical environment whereupon the daughter radionuclide bismuth-213 may be generated in situ for immediate use in a subject in need of radiotherapy. The actinium-225 may be packaged in a suitable generator device prior to or after delivery.

It is contemplated further that the actinium-225 produced by the method described herein is, per se, useful as a radiotherapeutic. The natural decay cascade of actinium-225 has a more potent therapeutic benefit derived from the sequential emission of four alpha particles from the actinium-225 and its three daughters. Thus, the system to produce bismuth-213 for in situ radiotherapeutic applications also is effective to produce radiotherapeutic actinium-225. It is further contemplated that francium-221, as the first daughter and with a half-life t_{1/2}=4.8 min, also may be produced in situ for radiotherapeutic applications.

The following examples are given for the purpose of illustrating various embodiments of the invention and are not meant to limit the present invention in any fashion.

### EXAMPLE 1

Radium-225 Production

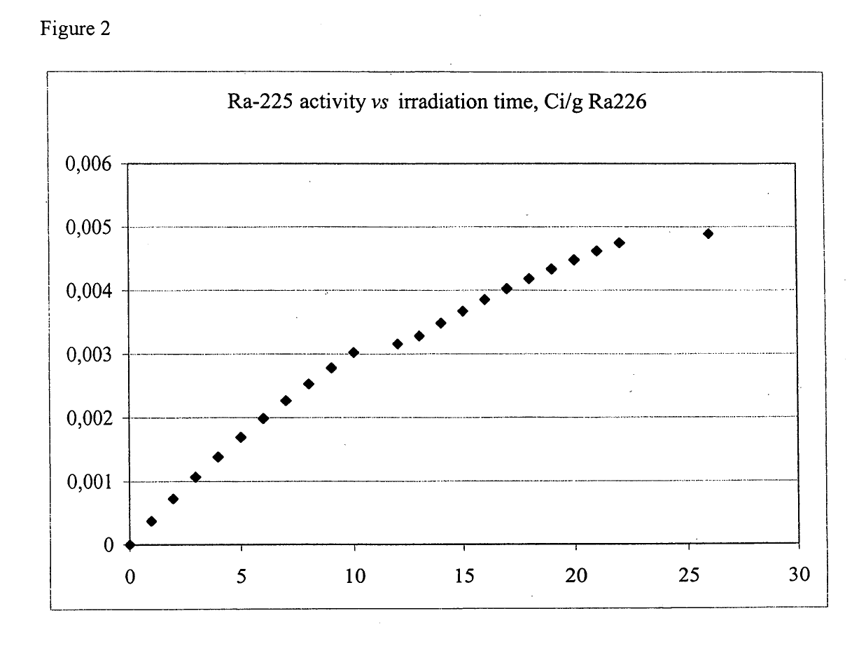

Radium-226 is irradiated in a fast-neutron reactor, at high neutron energies over a period of about 27-30 days. The desired reaction, radium-226 (n,2n) radium-225 is dominant with estimated yields of ˜5 mCi per irradiated gram of radium-226. FIG. 2 depicts he theoretical production yield. The production activities of Radium-225 is given as a function of irradiation time for a 1.0 gram Radium-226 target at a neutron energy of 10 mV.

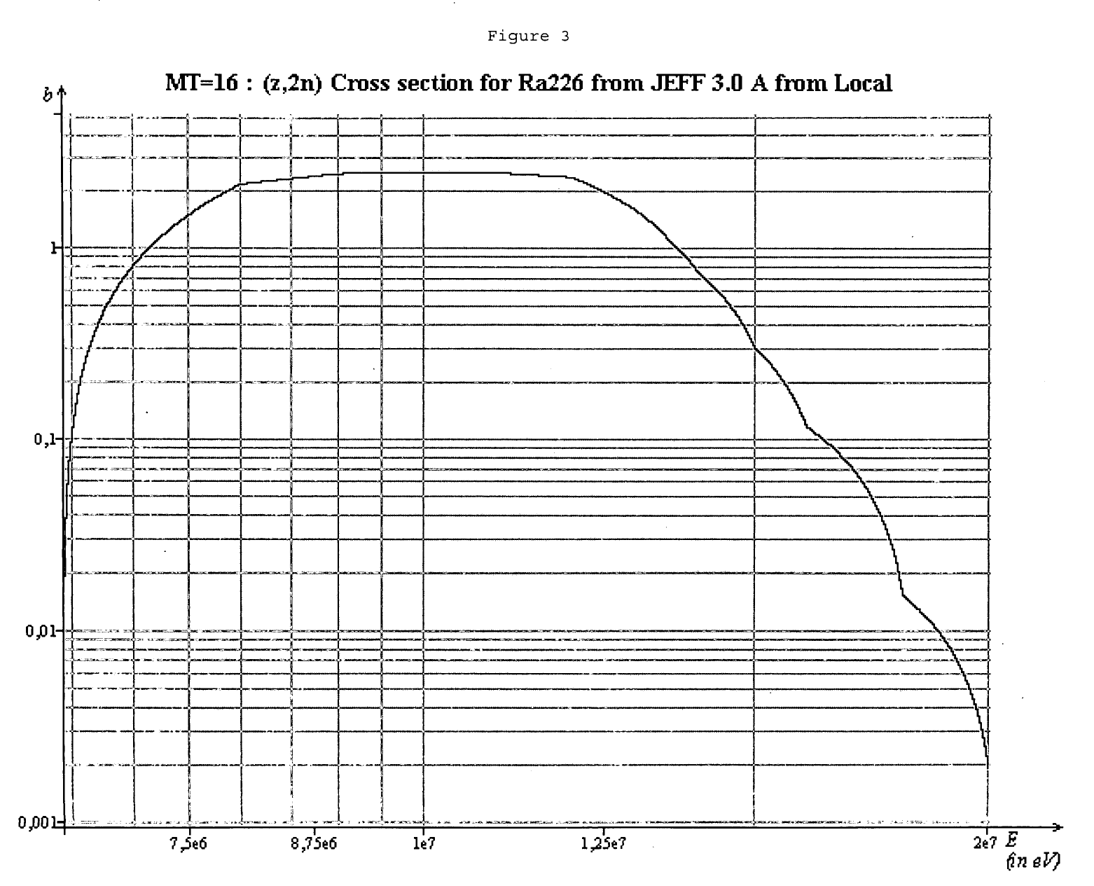

FIG. 3 is the Radium-226 (n,2n) cross-section curve as a function of energy. As the cross-section curve rises to about 2.5 barns, the activity of radium-225 produced rises to about 5 mCi of radium-225 per initial gram of radium-226. In Table 1 the cross-section values for radium-226 (n,2n) state were determined as a MT 16 reaction type, i.e., (z,2n), using the JEFF 3.0/A neutron activation file.

TABLE 1

| Neutron Energy, E | Cross-section |
|---|---|
| (eV) | (barns) |
| 6.4218E6 | 0.0 |
| 8.0E6 | 2.1873 |
| 9E6 | 2.4882 |
| 1.0E7 | 2.5297 |
| 1.1E7 | 2.5071 |
| 1.2E7 | 2.3801 |
| 1.3E7 | 1.5755 |
| 1.35E7 | 1.1218 |
| 1.4E7 | 0.75571 |
| 1.5E7 | 0.30897 |
| 1.6E7 | 0.11722 |
| 1.8E7 | 0.015337 |
| 2.0E7 | 0.0019053 |

### EXAMPLE 2

Production of Actinium-225 and Bismuth-213

Actinium-225 is the decay product of radium-225 produced by the reaction Ra-225→Ac-225+β⁻. To determine the activity of actinium-225 produced by radium-225 decay:
λ_{Ra-225}÷λ_{Ac-225}=activity_{Ac-225}÷activity_{Ra-225}
where λ is the decay constant, defined as λ=ln 2+t_{1/2} of the isotope concerned, and activity is defined as the activity in becquerels or curies. In this case, as the asymptotic region is reached, that ratio is ˜1.482, so the activity of the actinium-225 after about 4 half-life periods, i.e., approximately 40 days, have elapsed, will be about 1.5 times the activity of the radium-225 manufactured in the irradiation, Ra-226 (n,2n) Ra-225.

Bismuth-213 with a half-life t_{1/2}=45.6 minutes is a daughter of actinium-225, t_{1/2}=10.0 days. Using the equations of secular equilibrium, where the decay constant, λ_{d}, of the daughter nuclide compares to the decay constant, λₚ, of the parent nuclide by, λ_{d}>>λₚ, after a number of half-lives, i.e., generally >4, of the shorter-lived Bi-213 daughter, the activity of the Bi-213 isotope will grow asymptotically to an activity approximately equal to the activity of the longer-lived parent isotope, actinium-225. After reaching the asymptotic region of the isotopic growth curve; i.e., ˜138 minutes in the case of Bi-213, this isotope may be chemically separated from its parent radionuclide, purified and utilized in the desired way.

### EXAMPLE 3

Improved, Lower Cost Production of Bismuth-213

As the yield of actinium-225 is renewed every 3 weeks, chemical separation of the actinium from the radium can be done about 18 times each year. Over a year, 18×15 mCi=270 mCi of actinium-225 would be available for disbursement to clinical settings for use in bismuth-213 generators. The numbers provided herein are based on the use of the generated bismuth-213 for treatment of subjects with acute myelogenous leukemia (AML). However, allowing for about 7 days for delivery of the actinium-225 and fabrication of the generators, approximately 10 mCi of actinium-225 per month, or 120 mCi per year, of actinium-225 can be made available in the clinical setting for the treatment of AML. Because of the law of secular equilibrium governing isotope decay, the activity of bismuth-213 produced by the decay of actinium-225 will always be equal to the activity of the Ac-225 precursor used as the bismuth-213 generator.

Each generator or “cow” fabricated from the actinium-225 can be tapped or “milked” for bismuth-213 at the rate of 10 mCi of bismuth-213 every 3 hours for one week in the clinical setting. After 56 milkings every 3 hours, the cow will be exhausted and will have to be returned for recharging. 56 milkings×10 mCi of Bi-213 per milking per cow is 560 mCi per week per activated gram of radium-226. That is an amount sufficient to treat between 6 and 8 patients per charged generator at 70 mCi to 100 mCi per patient per treatment. 10 mCi of Ac-225 per tri-weekly acquisition is sufficient to charge 1 generator 18 times per year; i.e. to treat 6-8 patients every three weeks or approximately 108-144 patients per year per the original gram of radium-226. Because the naturally-occurring radium has a half-life t_{1/2}=1600 years, the 1 gram of radium-226 is therefore effectively never exhausted. The yield, from that same gram of radium, of 15 mCi of Ac-225 is, by the very nature of the re-activation process, therefore renewed every 20 days thereafter, indefinitely.

Any publications or patents mentioned in this specification are indicative of the levels of those skilled in the art to which the invention pertains. Further, these publications are incorporated by reference herein to the same extent as if each individual publication was specifically and individually incorporated by reference.

One skilled in the art will readily appreciate that the present invention is well adapted to carry out the objects and obtain the ends and advantages mentioned, as well as those inherent therein. The present examples along with the methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

What is claimed is:

1. A method of producing radium-225, comprising:
irradiating radium-226 with neutrons having an energy effective to substantially produce radium-225 therefrom.

2. The method of claim 1, further comprising:
separating actinium-225 produced via decay of the radium-225 from the radium-226.

3. The method of claim 2, wherein about 15 mCi of actinium-225 is produced from the radium-226.

4. The method of claim 2, further comprising:
enclosing said actinium-225 in a generator device effective to generate bismuth-213 therefrom.

5. The method of claim 2, further comprising:
re-irradiating the radium-226 with said neutrons.

6. The method of claim 1, wherein said neutron energy is about 5 MeV to about 20 MeV.

7. The method of claim 1, wherein the radium-226 is irradiated about 20 to about 40 days.

8. The method of claim 7, wherein the radium-226 is irradiated about 21 days.

9. The method of claim 8, wherein about 5 mCi of radium-225 is produced.

10. A method of producing actinium-225, comprising:
irradiating radium-226 with neutrons having an energy effective to substantially produce radium-225, said radium-225 subsequently decaying thereby producing actinium-225.

11. The method of claim 10, further comprising:
separating the actinium-225 from said radium-226.

12. The method of claim 11, further comprising:
enclosing said actinium-225 in a generator device effective to generate bismuth-213 therefrom.

13. The method of claim 11, further comprising:
re-irradiating the radium-226 with said neutrons.

14. The method of claim 10, wherein said neutron energy is about 5 MeV to about 20 MeV.

15. The method of claim 10, wherein the radium-226 is irradiated about 20 to about 40 days.

16. The method of claim 15, wherein the radium-226 is irradiated about 21 days.

17. The method of claim 10, wherein about 5 mCi of radium-225 is produced.

18. The method of claim 10, wherein about 15 mCi of actinium-225 is produced from the radium-225.

19. A method of producing actinium-225, comprising:
(a) irradiating radium-226 with neutrons at an energy effective to substantially produce radium-225, said radium-225 subsequently decaying to actinium-225;
(b) separating the actinium-225 from the radium-226;
(c) re-irradiating said radium-226; and
(d) repeating steps (a) to (c).

20. The method of claim 19, further comprising:
enclosing said actinium-225 in a generator device effective to generate bismuth-213 therefrom.

21. The method of claim 19, wherein said neutron energy is about 5 MeV to about 20 MeV.

22. The method of claim 19, wherein the radium-226 is irradiated about 20 to about 40 days.

23. The method of claim 22, wherein the radium-226 is irradiated about 21 days.

24. The method of claim 19, wherein about 5 mCi of radium-225 is produced.

25. The method of claim 19, wherein about 15 mCi of actinium-225 is produced from the radium-225.

26. A system for supplying radiotherapeutic bismuth-213 in situ to a subject in need of radiotherapy, comprising:
a reactor having a substantial flux of fast neutrons, said reactor configured to generate neutrons with sufficient energy effective to activate radium-226 disposed therein via the reaction ²²⁶Ra (n,2n) ²²⁵Ra;
means for separating actinium-225 produced via decay of radium-225 from the radium-226; and
a generator device adapted to contain said actinium-225 and to generate radiotherapeutic bismuth-213 therefrom in situ for the subject.

27. The system of claim 26, wherein said neutron energy is about 5 MeV to about 20 MeV.

28. The system of claim 26, wherein about 5 mCi of radium-225 is produced from said activated radium-226.

29. The system of claim 26, wherein about 15 mCi of actinium-225 is produced from the radium-225.
